(19) United States
(12) Patent Application Publication
(10) Pub. No.: US 2008/0102150 A1
(43) Pub. Date: May 1, 2008

(54) APPARATUS FOR PRODUCING OPTICAL ELEMENT

(75) Inventor: Shinji TANAKA, Chiyoda-ku (JP)

Correspondence Address: OBLON, SPIVAK, MCCLELLAND MAIER & NEUSTADT, P.C., 1940 DUKE STREET, ALEXANDRIA, VA, 22314, US

(73) Assignee: ASAHI GLASS COMPANY LIMITED, Chiyoda-ku (JP)

(21) Appl. No.: 11/955,973

(22) Filed: Dec. 13, 2007

Related U.S. Application Data
(63) Continuation of application No. PCT/JP2006/312826, filed on Jun. 27, 2006.

(30) Foreign Application Priority Data
Jun. 30, 2005 (JP) 2005-192521

(51) Int. Cl. B29C 43/14; B29D 11/00; B29C 43/52

(52) U.S. Cl. 425/210; 425/451

(57) ABSTRACT

An apparatus for producing optical elements is provided, which can convey a mold conveyed along a conveying path without having a waiting time in each step, which can maintain an atmosphere of each step in an optimum condition, which can minimize influence on other steps at a time of e.g. maintenance, to maintain the qualities of molding materials and products and to prevent deterioration of mold, and which improves productivity.

The apparatus comprises a conveying path 2 constituted by an outgoing path 21 and a returning path 23 opposed to each other and connecting paths 22 and 24 connecting respective ends of the outgoing path 21 with ends of the returning path 23, the conveying path 2 circulating a mold 5 containing a molding material 3 along the conveying path 2, wherein the outgoing path 21, the returning path 23 and the connecting paths 22 and 24 are each constituted by a plurality of sections, and each section accommodates a group of molds comprising one or a plurality of molds 5, and the apparatus 1 comprises individual feeding means 6c and 6d feeding a group of molds 5 each time, and simultaneous feeding means 7 feeding a plurality of groups of molds 5 at the same time, and which carries out an individual feeding and a simultaneous feeding at respective timings.

### TECHNICAL FIELD

The present invention relates to a production apparatus for press-molding an optical element such as a high-precision glass lens used for optical instruments.

### BACKGROUND ART

Apparatuses for producing glass lenses, which press-mold a heated and softened glass molding material by compression, are disclosed in e.g. Patent Documents 1 and 2. Since these apparatuses can omit production steps such as e.g. polishing, they are widely used as production apparatuses capable of carrying out mass production in recent years.

A process for producing glass lenses by such a production apparatus is as follows. For example, a glass molding material premolded to have a ball shape is set in a mold constituted by a top mold, a bottom mold and a body mold, heated to about 500° C. in a heating step to be softened, compressed to be molded into a lens product, cooled and taken out as a product. Each of these steps is carried out in a chamber filled with non-oxidative atmosphere in which no oxygen enters, to prevent oxidation of especially a heated mold, and a glass molding material in the mold is sequentially conveyed to heating, press-molding and cooling steps arranged in a conveying path of linear or circular shape.

However, a production process of glass lens has a plurality of steps that are heating, press-molding and cooling as described above, and durations of these steps are different from each other. However, in the production apparatuses disclosed in the above-mentioned Patent Documents, molds passing through the respective steps are conveyed simultaneously and sequentially, and thus, conveyance has to be carried out at a predetermined interval based on a step having the longest duration, for example, the heating step. Accordingly, in this case, after a molding treatment is finished in the press-molding step, a waiting time occurs before a mold enters into the cooling step, which lowers productivity.

Further, since a plurality of steps are carried out in a single space, influence of temperatures of adjacent steps tends to occur. For example, if a portion adjacent to the heating step has a normal temperature, a temperature slope is formed in a mold in the heating zone, which influences molding accuracy. Further, if a part of chamber is open for supplying molding materials or taking out products or for maintenance, air enters into the chamber to oxidize a mold, a glass molding material or a product, which causes a problem of deterioration of the mold and deterioration of product quality. Further, at a time of taking out a mold in a specific step section for maintenance, the temperature of entire chamber has to be lowered before opening a doorway to open the chamber to the atmosphere. Accordingly, there occurs an inefficiency that the temperature of a step section not requiring maintenance also has to be lowered, or a cooling step zone has to be extended, which increases the size of entire apparatus.

Patent Document 1: JP-A-3-252322

Patent Document 2: JP-A-4-164826

### DISCLOSURE OF THE INVENTION

### Problems to be Solved by the Invention

The present invention has been made considering the above-mentioned prior arts, and it is an object of the present invention to provide an apparatus for producing optical element which can convey a mold along a conveying line without having waiting time in each step, which can maintain an atmosphere of each step to optimum conditions to minimize an influence to other steps at a time of e.g. maintenance, to maintain qualities of molding materials and products and to prevent deterioration of molds, and which improves productivity.

### Means for Solving the Problems

The present invention has the following features as its gists.

(1) An apparatus for producing optical element, which comprises a conveying path constituted by an outgoing path and a returning path opposed to each other and connecting paths connecting ends of the outgoing path with ends of the returning path, the conveying path circulating a mold containing a molding material along the conveying path, wherein the outgoing path, the returning path and the connecting paths are each constituted by a plurality of sections, and each section accommodates a group of molds constituted by one or a plurality of molds each having a top mold and a bottom mold;

the apparatus being characterized in that the apparatus comprises individual feeding means for feeding a group of molds each time, and simultaneous feeding means for feeding a plurality of groups of molds at the same time, and carries out an individual feeding and a simultaneous feeding at respective timings.

(2) The apparatus for producing optical element according to the above (1), which comprises in the conveying path a heating zone for heating a mold containing a molding material, a molding zone for press-molding the molding material, a cooling zone for cooling a mold after the molding, a mold reassembly zone for removing a top mold from the mold after the cooling, and placing the top mold on a bottom mold in which a new molding material is set, a product retrieving zone for retrieving a product from a bottom mold from which the top mold is removed, and a molding material supply zone for setting a molding material in the bottom mold from which the product was taken out; and

which further comprises a product collecting zone adjacently to the product retrieving zone, a molding material collecting zone adjacently to the molding material supply zone, and a sealing chamber filled with non-oxidative atmosphere, wherein the conveying path, the product collecting zone and the molding material collecting zone are provided in the sealing chamber.

(3) The apparatus for producing optical element according to the above (2) wherein the heating zone is provided in the outgoing path, the molding zone is provided in the connecting path in the downstream side of the heating zone, and the cooling zone is provided in the returning path.

(4) The apparatus for producing optical element according to the above (3), wherein the mold reassembly zone is provided in the middle of the returning path so as to continue from the cooling zone, and a top mold removed in the mold reassembly zone bypasses to an opposing position in the returning path side.

(5) The apparatus for producing optical element according to the above (3), wherein the mold reassembly zone is provided in the connecting path in the downstream side of the cooling zone.

(6) The apparatus for producing optical element according to any one of the above (2) to (5), wherein the heating zone, the molding zone and the cooling zone are partitioned from other process zones in the conveying path by a partition wall having an opening through which the mold can pass.

(7) The apparatus for producing optical element according to any one of the above (2) to (6), wherein based on a zone requiring the shortest process duration among the heating zone, the molding zone and the cooling zone, the number of sections in each of other zones is determined.

### EFFECTS OF THE INVENTION

According to the embodiment of the above (1), along a conveying path rectangularly circulating, conveying means for simultaneous feeding which feeds a plurality of groups of molds simultaneously, and conveying means for individual feeding which feeds only a group of molds, operate independently at different timings, feeding timing can be independently changed according to process duration of each step, and accordingly, conveyance can be carried out under an optimum condition for each step, and treatment is possible without having unnecessary waiting time or shortage of time, which improves productivity.

According to the embodiment of the above (2), sections for carrying out all steps necessary for press-molding treatment, namely, a heating step, a molding step, a cooling step, a mold reassembly step, a product retrieving step and molding material supplying step, are provided in a conveying path. The conveying path, a product collecting zone such as a product tray for collecting pressed products, and a molding material collecting zone such as a molding material tray on which molding materials are placed, are provided in a sealed chamber, and the sealed chamber is filled with a non-oxidative gas such as nitrogen gas to form a non-oxidative atmosphere. Accordingly, no e.g. oxygen gas enters from the outside into a series of production process line, which prevents deterioration of quality of products due to oxidization or prevents deterioration of a mold due to oxidation.

Further, by providing the molding material collecting zone and the product collecting zone in the sealed chamber together with the conveying path having the mold reassembly zone and the product retrieving zone, molding materials and products are maintained under the same temperature conditions as those of the molds on the conveying path. Accordingly, at a time of taking out the products, it is unnecessary to cool the molds to a room temperature, and thus, cooling time can be reduced to improve productivity. Further, it is possible to reduce the length of cooling zone to downsize and simplify the shape of entire apparatus.

According to the embodiment of the above (3), in a conveying path circulating rectangularly, among an outgoing path and a returning path constituting two rows opposed to each other, a heating zone is provided in the outgoing path, and a molding zone is provided in a connecting path connected with the end of the outgoing path, and a cooling zone is provided in the returning path, whereby these zones are disposed along the conveying path efficiently and compactly. Further, by providing the molding zone requiring generally a shorter process duration than those of heating and cooling zones, in the connecting path at an end of the conveying path, more number of sections for the heating zone and the cooling zone, can be arranged in the outgoing and returning paths, molds in these sections can be conveyed by a simultaneous feeding, and a mold in the molding zone can be appropriately conveyed by an individual feeding on the connecting path so as to conform to its process duration. Accordingly, entire molding process can be carried out efficiently.

According to the embodiment the above (4), a mold reassembly zone is provided so as to continue from the cooling zone on the returning path, a top mold taken out here bypasses to an opposing position in the outgoing path, and placed on a bottom mold on the outgoing path. Accordingly, circulation line of a top mold in the conveying path becomes shorter than the circulation line of a bottom mold. Accordingly, it is possible to reduce the number of top molds, and to produce press-molded products efficiently by smaller number of molds.

According to the embodiment of the above (5), by providing the mold reassembly zone in a connecting path in a downstream side of the cooling zone being an end of one of the conveying paths, while a mold is conveyed in the connecting path, removal of a top mold, retrieval of a product and supply of a molding material can be carried out efficiently. Further, it is possible to arrange the molding material collecting zone or the product collecting zone outside of the end portion of the conveying path efficiently in terms of the space and compactly.

According to the embodiment of the above (6), the heating zone, the molding zone and the cooling zone in which influence of heat and influence of oxidative gas are particularly significant to products, are isolated from other portions of the conveying path by a partition wall. Accordingly, even if other portions are opened to the outside and their temperatures are decreased to a room temperature, thermal influence to e.g. the heating zone can be suppressed. Accordingly, uniform temperature distribution of a mold is maintained without having a temperature slope, and high precision press-molded products can be obtained.

In this case, the partition wall is preferably constituted by a material having a large heat-insulation properties to cut off thermal influence.

In the partition wall, an opening allowing a mold to pass through, is formed. A door may be provided to the opening.

The door may, for example, be usually open and closed as the case requires (e.g. in the event that the above-mentioned other portions are open to the outside and atmospheric air flows into the chamber). Or else, the door may be usually closed and open at a time of feeding a mold.

The partition wall not only cuts off thermal influence to e.g. the heating zone and the molding zone, but also prevents outside air from entering into e.g. the heating zone and the molding zone, to prevent oxidation of press products to improve their qualities, and at the same time, to prevent deterioration of molds due to oxidation.

According to the embodiment of the above (7), since the number of sections for each step is determined based on a step requiring the shortest process duration, it is possible to feed a mold in a section for the shortest process duration step by an individual feeding, it is possible to increase the number of sections for adjacent process steps requiring longer process durations, and it is possible to convey a plurality of groups of molds by a simultaneous feeding. Accordingly, there is no waste waiting time for a mold in the shortest process duration step after completion of the treatment of the step, and it is possible to feed out a mold at a completion of each step efficiently and smoothly, which improves productivity.

### BRIEF EXPLANATION OF THE DRAWINGS

FIG. 1: A schematic plan view of a production apparatus of the present invention.

FIG. 2: A vertical cross sectional view of a mold according to the present invention.

FIG. 3: An explanation view showing the process sequence by the production apparatus of FIG. 1.

FIG. 4: An explanation view showing the process sequence by a production apparatus having a different conveying path.

FIG. 5: A plan view showing still another example of conveying path.

FIG. 6: A plan view showing an example of the present invention.

FIG. 7: A plan view showing another example of the present invention.

FIG. 8: A plan view showing still another example of the present invention.

### EXPLANATION OF NUMERALS

1: Production apparatus, 2: Conveying path, 2a, 2b, 2c, 2d, 2e, 2f, 2g, 2h: Zone, 3: Molding material, 4: Product, 5: Mold, 6a, 6b, 6c, 6d, 6e: Individual feeding apparatus, 7: Simultaneous feeding apparatus, 8: Rotational work robot, 8a: Ring, 9: XY table, 10: Chamber, 12: Molding material supply zone, 13: Mold reassembly zone, 14: Heating zone, 15: Molding zone, 16: Cooling zone. 17: Product retrieving zone, 18: Mold exchange zone, 19: Partition wall, 21: Outgoing path, 22, 24: Connecting path, 23: Returning path, 26: Chuck, 27: Mold centering apparatus, 30: Molding material chamber, 31: Molding material tray, 32: Molding material supply robot, 33: Robot, 40: Product chamber, 41: Product tray, 42: Product retrieving robot, 51: Top mold, 52: Body mold, 53: Bottom mold, 71a, 71b: Feeding cylinder, 71c: Comb-tooth conveyer, 71d: XY table, 72: Mold retrieving zone, 73: Mold loading zone, 74: Working zone, 75: Molding material zone, 76: Cleaning zone, 77: Product zone.

### BEST MODE FOR CARRYING OUT THE INVENTION

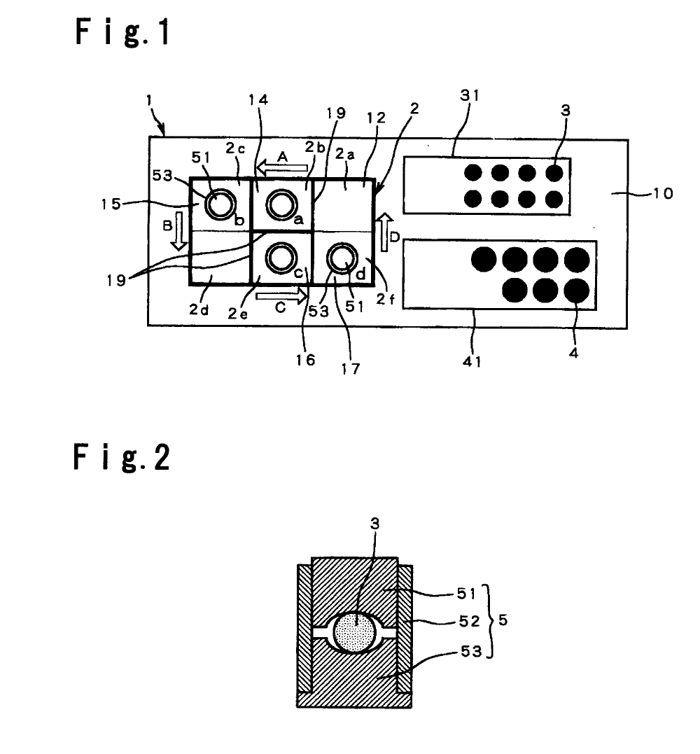

FIG. 1 is a schematic plan view of a production apparatus 1 for optical element of the present invention. A conveying path 2, a molding material tray (molding material collecting zone) 31 on which molding materials 3 being glass balls are placed, and a product tray (product collecting zone) 41 on which molded products 4 are placed, are disposed in a chamber (sealed chamber) 10 filled with an inert gas such as nitrogen.

The conveying path 2 is constituted by a plurality of sections 2a to 2f. Three sections 2a to 2c in the upper row constitute an outgoing path (arrow A), and three sections 2d to 2f in the lower row constitute a returning path (arrow C). Two sections 2c and 2d at the left end and two sections 2a and 2f at the right end constitute connecting paths (arrows B and D) respectively, that connect the outgoing path and the returning path disposed in parallel in the upper and lower rows. In the conveying path 2, molds (a) to (d) circulate in a rectangular form as shown by arrows A, B, C and D. The figure shows an example that a mold is present in each section (an example that a single mold constitutes a group of molds). A section 2b in the center of the outgoing path in the upper row, constitutes a heating zone 14 for conducting a heating step, two sections 2c and 2d in the left side connecting path continuing from the heating zone 14, constitute a molding zone 15 for conducting a molding step, a section 2e in the center of the returning path in the lower row, constitutes a cooling zone 16 for conducting a cooling step, a section 2f in the right side connecting path continuing from the cooling zone 16, constitutes a product retrieving zone 17 for retrieving products, and a section 2a continuing from the product retrieving zone 17, constitutes a molding material supply zone 12. Each of 4 (4 groups of) molds (a) to (b) shown in the figure shows a mold in a state that a top mold 51 is set on a bottom mold 53 (refer to FIG. 2).

A partition wall 19 is provided to separate the heating zone 14 from the molding material supply zone 12 and separate the cooling zone 16 from the product retrieving zone 17. Further, another partition wall 19 is provided to separate the molding zone 15 from the heating zone 14 and cooling zone 16. Further, still another partition wall 19 is provided between the heating zone 14 and the cooling zone 16. The partition walls 19 are each made of a heat-insulating material, and provided with an opening formed to allow a mold to pass through. To the opening, a door is provided, which is usually closed and opens at a time of conveying a mold. Or else, the door may usually open and close in the event that the flowing of a gas has to be stopped for e.g. maintenance.

FIG. 2 shows an example of a shape of a mold 5. The mold 5 is constituted by a top mold 51, a bottom mold 53 and a body mold 52 into which the top mold 51 and the bottom mold 53 are fit. After a molding material 3 is placed on the bottom mold 53, the top mold 51 is placed from the topside. The top mold and the bottom mold 53 are aligned to each other by the body mold 52 so that their axes are aligned into a single line.

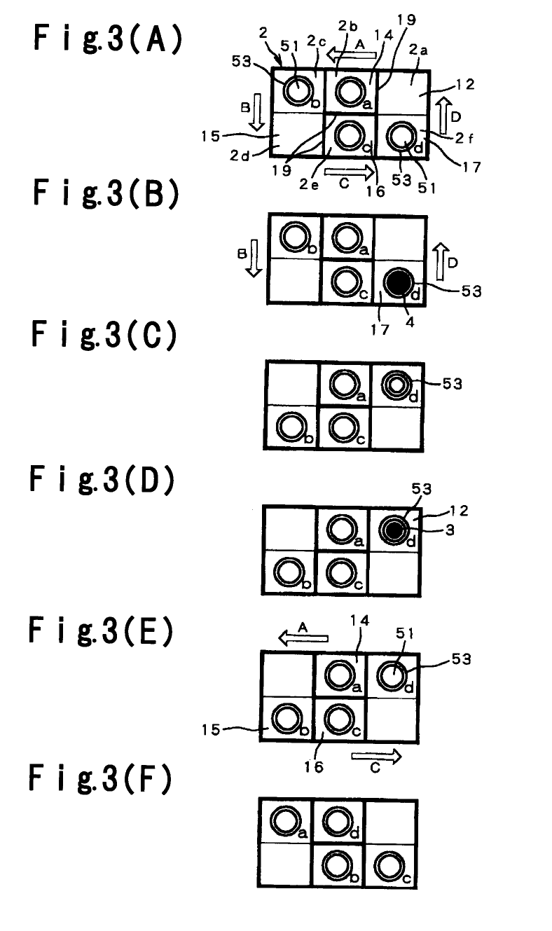

FIG. 3 is an explanation view of a production sequence by the conveying path 2 of FIG. 1. The process and the conveying sequence are described with reference to FIG. 3.

In FIG. 3 (A), a mold (a) in which a molding material is set is accommodated in a heating zone 14 (section 2b). In the heating zone 14, the mold (a) is heated to about 500° C. by a heater, not shown, to soften a molding material 3 being a glass ball. A mold (b) to which the heating step is completed and which is fed from the heating zone 14, is accommodated in a section 2c in a molding zone. A mold (c) is accommodated in a cooling zone 16 (section 2e), and cooled to a predetermined temperature by cooling means such as water-cooled circuit. In a product retrieving zone 17 (section 2f), a mold (d) is accommodated, which came out from the cooling zone 16 and to which a series of molding process is completed.

From this state, as shown in FIG. 3 (B), a top mold 51 is removed from the mold (d). Accordingly, a molded product 4 appears on a bottom mold 53. The product 4 is suctioned and taken out by e.g. a vacuum robot arm, and placed on a product tray 41 (FIG. 1).

Then, as shown in FIG. 3 (C), the mold (b) is conveyed to a lower row in the figure. Further, the mold (d) (only bottom mold) from which the product 4 is taken out, is conveyed to the upper row. Thus, conveying a mold at the ends individually in a vertical direction, is referred to as individual feeding in the present invention.

Subsequently, in FIG. 3 (D), the mold (b) is pressurized to carry out press-molding, and a molding material 3 supplied from a molding material tray 31 (FIG. 1) is placed on a bottom mold 53 of a mold (d). Thereafter, in FIG. 3 (E), a top mold 51 is placed on the mold (d).

In FIG. 3 (E), when all process durations for the mold (a) being subjected to a heating step in the heating zone 14, the mold (b) being subjected to a press-molding step in the molding zone 15 and the mold (c) being subjected to a cooling step in the cooling zone 16, are elapsed, the molds (a) and (d) in the outgoing path in the upper row in the figure and the molds (b) and (c) in the returning path in the lower row, are each simultaneously moved in the direction of arrows A and C respectively, whereby the apparatus becomes in the state of FIG. 3 (F). Such a conveyance of a plurality of molds arranged in a row simultaneously in a line direction, is referred to as simultaneous feeding in the present invention. From FIG. 3 (F), equivalent treatment and conveyance are repeated.

In the example of FIG. 3, the apparatus is configured so that a mold is present in each section, and this configuration is determined according to the number of molds to be processed in a section 2d in the molding zone 15 where the press-molding treatment is actually carried out. Namely, in this example, since only one mold is subjected to press-molding each time, one mold is placed in each section and the molds are sequentially conveyed. On the other hand, if it is possible to carry out press-molding to two or more plurality of molds simultaneously, the construction may be such that the plurality of molds to be press-molded simultaneously are grouped, and each section is configured to accept a group of molds (a plurality of molds) and each group is conveyed between sections by an individual feeding or a plurality of groups are conveyed to adjacent sections so that each group moves to respective next section.

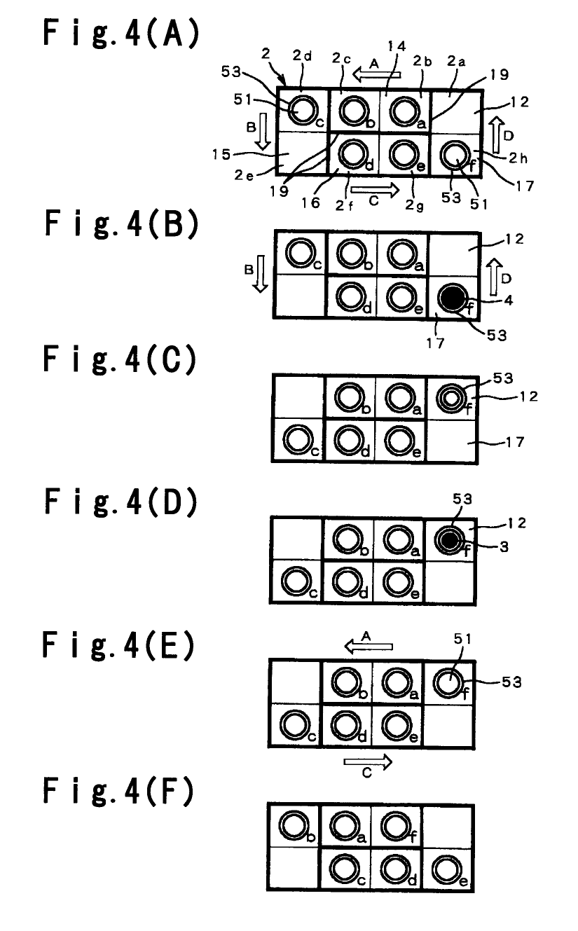

FIG. 4 shows an example in which the number of sections in the conveying path 2 is different, and the heating zone 14 and the cooling zone 16 are each constituted by two sections.

The conveying path 2 is constituted by eight sections 2a to 2h. Four sections 2a to 2d in the upper row constitute an outgoing path, four sections 2e to 2h in the lower row 4 constitute a returning path, and two sections 2d and 2e at the left end constitute a connecting path, and two sections 2h and 2a at the right end constitute another connecting path. Two sections 2b and 2c in the center of the outgoing path constitute a heating zone 14, and two sections 2f and 2g in the center of the returning path constitute a cooling zone 16. Sections 2d and 2e in the left side connecting path constitute a molding zone 15. A section 2h in the lower side of the right side connecting path constitutes a product retrieving zone 17, and a section 2a in the upper side constitutes a molding material supply zone 12. Partition walls 19 are provided to separate the heating zone 14, the molding zone 15 and the cooling zone 16 from one another and to separate them from the product retrieving zone 17 and the molding material supply zone 12, in the same manner as the above-mentioned example of FIG. 3.

In this example, in each of the outgoing path (sections 2a to 2d) in the upper row and the returning path (sections 2e to 2h) in the lower row, three pieces (three groups) of molds in three sections are fed simultaneously. Further, in each of the left side connecting path (sections 2d and 2e) and the right side connecting path (sections 2h and 2a), a single (a group of) mold is fed by an individual feeding. Operations of respective steps of the heating zone 12, the molding zone 15, the cooling zone 16, the product retrieving zone 17 and the molding material supply zone 12, are the same as those in the example of FIG. 3. Namely, from FIG. 4 (A), the state of the apparatus turns into a state of FIG. 4 (B) and a top mold 51 is removed from a mold in the product retrieving zone 17, to take out a product 4. In FIG. 4 (C), individual feedings are carried out in the connecting paths on both ends. In FIG. 4 (D), a molding material 3 is set in a bottom mold 3 in the molding material supply zone 12. In FIG. 4 (E), a top mold 51 is placed on the bottom mold 53 in which the molding material 3 is set. In FIG. 4 (F), molds in the outgoing path A and the returning path C are fed by a simultaneous feeding to return to FIG. 4 (A).

In the example of FIG. 4, particularly in a case where the process durations of the heating zone 14 and the cooling zone 16 are about twice of the process duration of the molding zone 15, it is possible to remove waiting time in each zone to improve efficiency of operation in each zone, and to improve productivity.

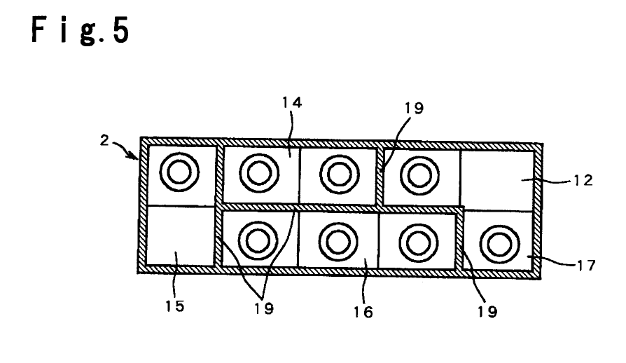

FIG. 5 shows an example in which the number of sections in each step in the conveying path 2 is further different, namely, the heating zone 14 is constituted by two sections and the cooling zone 16 is constituted by three sections. By configuring the apparatus having such numbers of sections in a case where the duration of the heating process is about twice of that of the press-molding step and the duration of the cooling step is three times of that of the press-molding step, it is possible to operate the apparatus efficiently without waiting time by combining of simultaneous feedings and individual feedings.

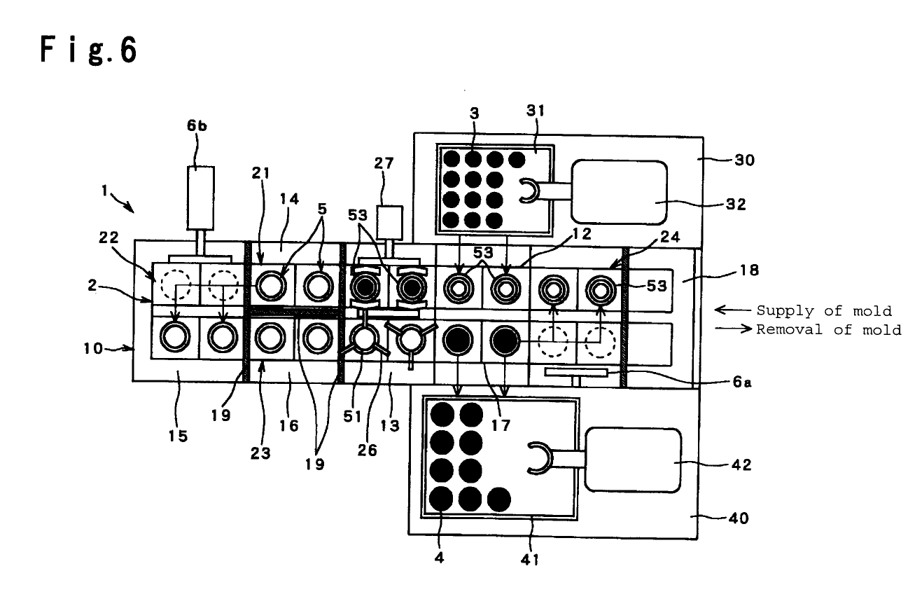

FIG. 6 shows an example of a production apparatus for optical element of the present invention.

A production apparatus 1 comprises three chambers that are a chamber 10 (sealed chamber) for accommodating a conveying path 2, a molding material chamber 30 for collecting and accommodating molding materials 3, and a product chamber 40 for collecting and accommodating products 4, and each of these chambers is filled with a non-oxidative atmosphere such as a nitrogen atmosphere. Here, these three chambers may constitute a common single sealed chamber. In the molding material chamber 30, a molding material tray 31 on which molding materials 3 being glass balls are placed, and a molding material supply robot 32 for supplying the molding materials 3 to a predetermined position in the conveying path 2, are provided. Exchange of the molding material tray 31, is carried out through an in-out port, not shown, opened and closed, and at this time, nitrogen gas is supplied to increase a gas pressure so that no air enters into the molding material chamber 30. Or else, an opening between the molding material chamber 30 and the chamber 10 accommodating the conveying path 2, is closed. In the product chamber 40, a product tray 41 for placing press-molded products 4 of molded optical elements, and a product retrieving robot 42 for taking out a molded product 4 from a mold and placing and arranging it on the product tray 41, are provided. Exchange of the product tray 41 is carried out through an in-out port, not shown, so that no air enters into the chamber 10.

In the chamber 10, a conveying path 2 comprising two rows that are an outgoing path 21 (upper row in the figure) for conveying a mold 5 in which a molding material 3 is set, and a returning path 23 (lower row in the figure), are provided, and the conveying path 2 is partitioned into portions corresponding to process steps by partition walls 19 having heat insulation properties. In this example, two molds arranged in a conveying direction are grouped into a group, and a space for a group of molds constitute a section.

The outgoing path 21 and the returning path 23 are connected with each other by connecting paths 22 and 24 at their left and right ends respectively. The connecting path 22 in the left side constitutes a molding zone 15. In the molding zone 15, a group (2 pieces) of molds is conveyed individually from the upper section in the figure to the lower section by an individual feeding apparatus 6b. In the lower section, a group (2 pieces) of molds is pressurized at the same time so that 2 pieces of molded products are press-molded at the same time.

Adjacently to the molding zone 15, a heating zone 14, a mold preassembly zone 13 adjacent thereto, and a molding material supply zone 12 adjacent thereto, are constituted in the outgoing path 21. Meanwhile, in the returning path 23, adjacently to the molding zone 15, a cooling zone 16, a mold reassembling zone 13 adjacent thereto, and a product retrieving zone 17 adjacent thereto, are constituted. In the connecting path 24 at the right end, a group (2 pieces) of bottom molds 53 from which products 4 are taken out, is conveyed individually by an individual feeding device 6a from a section in the returning path 23 in the lower side to a section in the outgoing path 21 in the upper side.

A mold exchange zone 18 is provided at the right end of the conveying path 2 in FIG. 6, and when a trouble occurs to a mold or a mold needs to be cleaned, the mold is conveyed to the mold exchange zone 18 to be replaced. Accordingly, the mold exchange zone 18 is not used in a normal molding process. An in-out port between the mold exchange zone 18 and the outside is, for example, provided with a double door so that no air enters into the chamber 10.

A mold to which a series of production process is completed, is conveyed from the cooling zone 16 to the mold reassembly zone 13, and a top mold 51 is removed from the mold 3 by a chuck 26 in the mold reassembly zone 13. The mold from which the top mold 51 is removed, is subsequently moved to the product retrieving zone 17, and a molded product is taken out from the mold. An empty bottom mold 53 is conveyed to the connecting path 24 at the end of the returning path 23, and individually fed to the outgoing path 21 side. A group of bottom molds 53 conveyed to a section at the right end of the outgoing path 21, is then moved to a molding material supply zone 12. A feeding operation in the outgoing path 21 is carried out together with other molds by a simultaneous feeding operation. The returning path 23 is also the same in this respect.

In the molding material supply zone 12, a molding material 3 is set on an empty bottom mold 53. Subsequently, in the mold reassembly zone 13, a top mold 51 removed in a lower section in the returning path 24 side, is fit onto the bottom mold 53 in which the molding material 3 is set. Then, the mold is heated in a heating zone 14, and subjected to press-molding in the molding zone 15.

From now, steps by the production apparatus 1 for optical elements of FIG. 6, are described.

Removal and attachment of a top mold 51, are carried out by a chuck 26 in the mold reassembly zone 13 in the figure. Namely, from a mold 5 conveyed from the cooling zone 16, a top mold 51 is removed and attached onto a bottom mold 53 in a section in the outgoing path 21 in the upper row in front of the heating zone 14. Before the top mold 51 is attached, the bottom mold 53 of a mold 5 is centered by a mold centering apparatus 27, and the top mold 51 is attached, whereby their axes are aligned to each other.

After a top mold 51 is removed in a section in the returning path 23 in the lower row in the mold reassembly zone 13, the counterpart bottom mold 53 is conveyed one section length in right direction in the figure together with other molds by a simultaneous feeding. Then, in the product retrieving zone 17, a product 4 is suctioned and taken out by a product retrieving robot 42, and placed on a product tray 41. Thereafter, the bottom mold 53 is conveyed further one section length, and conveyed to the outgoing path 21 in the upper row by an individual feeding apparatus 6a in the connecting path 24. The bottom mold 53 is conveyed one section length in left direction in the upper row by simultaneous feeding, and in the molding material supply zone 12, a molding material 3 is placed on the bottom mold 53 by a molding material supply robot 32. The bottom mold 53 is further conveyed one section length by simultaneous feeding, and in a section in the outgoing path 21 in the upper row in the mold reassembly zone 13, the above-mentioned attachment of a top mold 51 is carried out.

The mold 5 assembled by attaching the top mold 51 in the mold reassembly zone 13, is conveyed to the heating zone 14 by a simultaneous feeding apparatus, not shown. In the heating zone 14, the mold 5 is heated to a temperature at which the molding material 3 being a glass ball becomes soft enough to be moldable by pressurizing. A molding zone 15 is provided adjacently to the heating zone 14. The mold to which treatment in the heating step is finished, is conveyed to the molding zone 15 by the simultaneous feeding. Feeding from a section in the upper row in the molding zone 15 to a section in the lower row, is carried out individually by an individual feeding apparatus 6b, and a group (2 pieces) of molds are press-molded simultaneously in parallel by a press apparatus, not shown, in a section in the lower row to mold products 4 having predetermined dimensions.

A cooling zone is provided adjacently to the molding zone 15. The mold after the molding treatment, is conveyed to the cooling zone 16 by a simultaneous feeding in the lower row. In the cooling zone 16, the mold is cooled to a suitable temperature at which the quality of the product 4 is stabilized. The mold after the cooling is conveyed to the mold reassembly zone 13 by simultaneous feeding in the lower row. A series of these conveying operations are carried out in a counterclockwise direction by four individually controllable conveying means that are simultaneous is feeding apparatuses, not shown, for the outgoing path 21 in the upper row and for the returning path 23 in the lower row respectively and individual feeding apparatuses 6b and 6a for the connecting paths 22 and 24 at the left and right ends respectively.

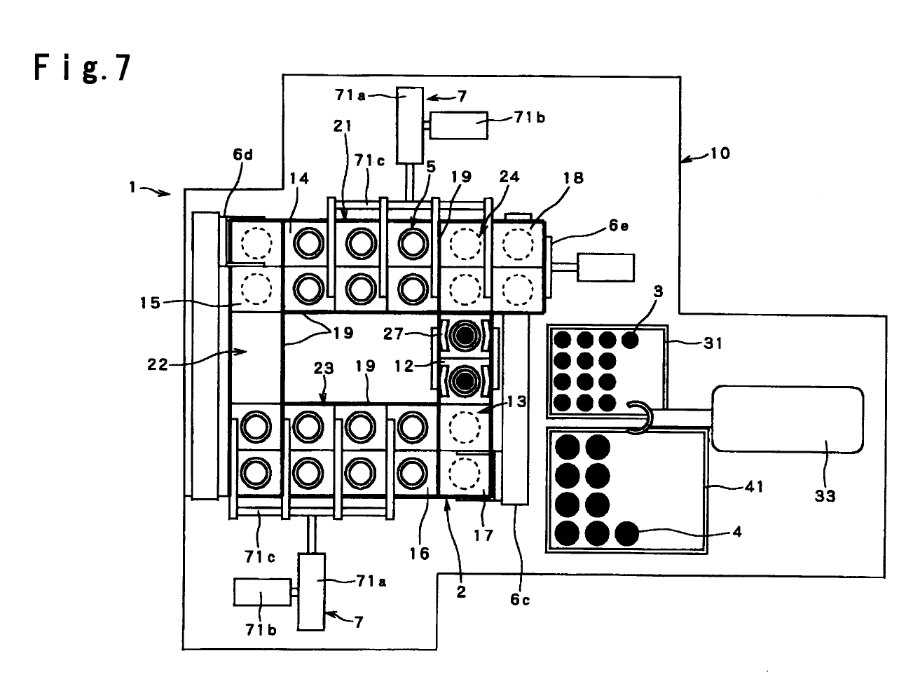

FIG. 7 shows another example of the present invention. In this example, two molds arranged perpendicularly to a conveying direction, are grouped into one group, and a space for this one group constitutes one section.

A production apparatus 1 is entirely accommodated in a chamber 10. The chamber 10 forms a sealing chamber and filled with no-oxidative atmosphere.

A conveying path 2 is provided in the chamber 10. Adjacently to the conveying path 2, a molding material tray 31 and a product tray 41 are provided and in the vicinity of them, a robot 33 for suctioning and conveying molding materials 3 and products 4, is disposed.

The conveying path 2 is, in the same manner as the above-mentioned examples, constituted by an outgoing path 21, a returning path 23 and connecting paths 22 and 24 at the left and right ends. In the outgoing path 21, a heating zone 14 is formed and in the returning path 23, a cooling zone 16 is formed. In the outgoing path 21 and the returning path 23, respective simultaneous feeding apparatuses 7 are provided. Each of the simultaneous feeding apparatuses 7 is constituted by feeing cylinders is 71a and 71b for feeding in lengthwise and crosswise directions respectively, and a comb-tooth conveyer 71c driven in lengthwise and crosswise directions by the feeding cylinders, and the simultaneous feeding apparatus 7 moves 4 groups (8 pieces) of molds one section length in a conveying direction in a simultaneous pressing (simultaneous feeding). Since the heating zone 14 and the cooling zone 16 each constituted by three sections, by repeating simultaneous feeding three times, molds in a state that the heating treatment or the cooling treatment is completed, are moved through the heating zone 14 and the cooling zone 16 respectively.

The outgoing path 21 (upper row) and the returning path 23 (lower row) are parallel with each other with a distance corresponding to one section. Accordingly, each of the connecting paths 22 and 24 in the left and right has a length corresponding to three sections. The left side connecting path 22 constitutes a molding zone 15 and provided with an individual feeding apparatus 6d.

In the right side connecting path 24 constituted by three sections, a lower section constitutes a product retrieving zone 17, a center section constitutes a molding material supply zone 12, and these two sections (central and lower sections) constitute a mold reassembly zone 13 at the same time. Namely, in the product retrieving zone 17, the top mold is removed and a product 4 is taken out. Subsequently, in the molding material supply zone 12 in the central section, a molding material is set on a bottom mold, and a top mold is fit on the bottom mold. Here, by a centering apparatus 27, on the top of the bottom mold whose position is aligned, a top mold is fit and axes of the top mold and the bottom mold are aligned into a single line. In the connecting path 24 performing such an operation, an individual feeding apparatus 6c is provided to feed a group (2 pieces) of molds by a distance corresponding to one section.

In the same manner as the above-mentioned examples, by partition walls 19, the heating zone 14, the molding zone 15 and the cooling zone 16 are mutually separated, and these zones 14, 15 and 16 are separated from the right side connecting path 24.

Two sections, that are an upper section in the connecting path 24 and a section in the right side neighbor, constitute a mold exchange zone 18 at the right end of the outgoing path 21. At a time of inspection or cleaning of a mold, or at a time when a mold need to be exchanged, the mold that have been used is taken out from the mold exchange zone 18 and put a new mold and send it out to the outgoing path 21 by an individual feeding apparatus 6e. The mold exchange zone 18 constituted by two sections, is preferably isolated by a partition wall 19.

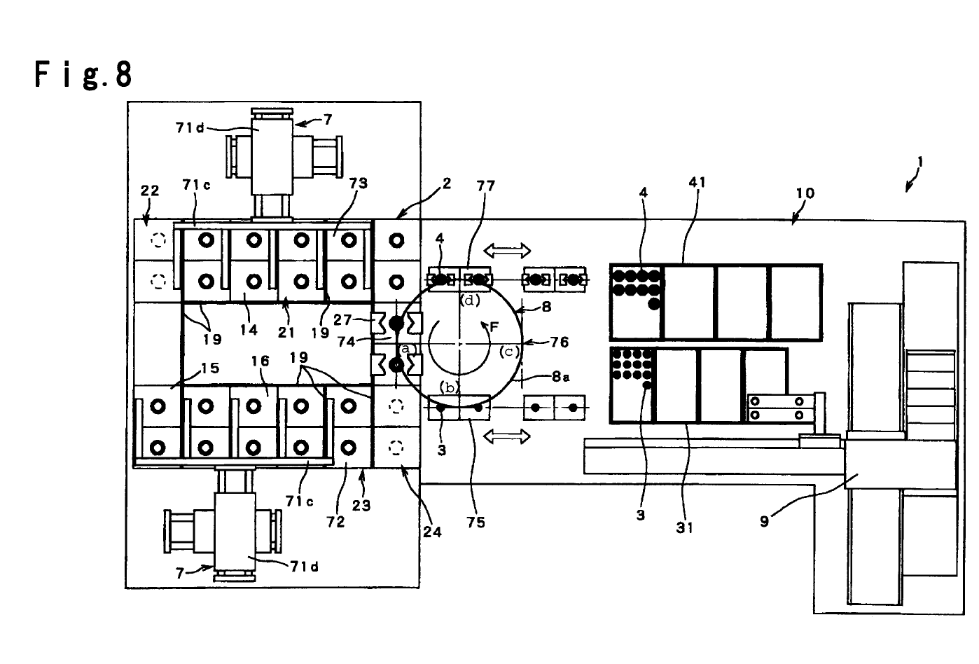

FIG. 8 is a construction explanation view of still another example of the present invention.

In this example, sequence and operation of each step for press-molding a molding material 3 using a mold circulating along a conveying path 2, is basically the same as the above-mentioned example of FIG. 7.

The example of FIG. 8 is different from the example of FIG. 7 in that: (1) a XY table 71d is employed as a simultaneous feeding apparatus 7, (2) adjacently to the cooling zone 16 in the outgoing path 23 and the heating zone 14 in the outgoing path 21, a mold retrieving zone 72 for taking out a defective mold and a mold introduction zone 73 for introducing new mold for replacement, are provided respectively, and (3) a construction of work robots for steps of product retrieval, molding material supply and mold reassembly in the connecting path 24, is different.

With respect to the above (1), by employing the XY table 71, the structure is simplified, assembly and control are also simplified and highly precise positioning becomes possible.

With respect to the above (2), in a case where a mold is damaged at a time of press-molding or mold reassembling, or in a case of e.g. maintenance, an exit (not shown) of the mold retrieving zone 72 is opened to take out the mold, and an entrance (not shown) of the mold introduction zone 73 is opened to introduce a replacement mold into the conveying path 2.

Accordingly, it is possible to exchange molds during a process of another step without stopping the molding process. The mold retrieving zone 72 is preferably isolated from the cooling zone 16, and the mold introduction zone 73 is preferably isolated from the heating zone 14 by respective above-mentioned partition walls 19.

The robot structure of the above (3) is described as follows. A section (corresponding to 2 pieces of molds) in the center of the right side connecting path 24, constitutes a working zone 74. To the working zone 74, a working tool arrives, which is one of working tools attached to four positions (a), (b), (c) and (d) of a ring 8a (or a rotational four radially projecting arms) of a rotational work robot 8 that is rotational as shown in an arrow F, to carry out a treatment to be described later. In the state of the figure, (a), (b), (c) and (d) portions of the rotational work robot 8 are at positions above the working zone 74, the molding material zone 75, a cleaning zone 76 and the product zone 77 respectively.

In this state, the (a) portion of the rotational work robot 8 picks up a top mold from a mold in the working zone 74. At this time, the (b) portion picks up a molding material 3 in the molding material zone 75.

Subsequently, the rotational work robot 8 rotates by 90°, whereby the (d) portion arrives at the working zone 74. The (d) portion is a product suction chuck, and it picks up a product 4 from a mold from which its top mold was removed in the work area 74.

Subsequently, the rotational work robot 8 further rotates by 90° (total 180°). The top mold picked up by the portion (a) moves onto the cleaning area 76, and is cleaned in the position. A (c) portion initially present over the cleaning zone 76 moves to a position above the working zone 74. The (c) portion is, for example, a cleaning tool comprising a compression gas nozzle to clean a bottom mold in the working zone 74.

When the rotational work robot 8 further rotates by 90° (total 270°), the (b) portion arrives at the working zone 74. The (b) portion is a portion picking up the molding material 3, and places the molding material 3 on the cleaned bottom mold.

When the rotational work robot 8 further rotates by 90° (total 360°), the (b) portion that picked up a product in the working zone 74 moves to the product zone 77. The product 4 is released from the rotational work robot 8 in the product zone 77, to be conveyed to a product tray 41. At this time, the (a) portion initially picked up the top mold moves to a position above the working zone 74. The top mold is placed on a bottom mold in the working zone 74 in which a molding material is set.

Then, an individual feeding is carried out in sections in the connecting path 24, whereby next molds are conveyed into the working zone 74.

To these next molds, the above-mentioned treatments are repeated.

Here, a reference numeral 9 in the figure indicates a XY table which conveys a molding material 3 from a molding material tray 31 to a molding material zone 75, and conveys a product 4 from a product zone 77 to the product tray 41.

### INDUSTRIAL APPLICABILITY

The present invention can be applied to a production method of molded products, which has a plurality of steps such as heating and cooling and which press-molds a molding material using a mold.

The entire disclosure of Japanese Patent Application No. 2005-192521 filed on Jun. 30, 2005 including specification, claims, drawings and summary is incorporated herein by reference in its entirety.

What is claimed is:

1. An apparatus for producing optical element, which comprises a conveying path constituted by an outgoing path and a returning path opposed to each other and connecting paths connecting ends of the outgoing path with ends of the returning path, the conveying path circulating a mold containing a molding material along the conveying path, wherein the outgoing path, the returning path and the connecting paths are each constituted by a plurality of sections, and each section accommodates a group of molds constituted by one or a plurality of molds each having a top mold and a bottom mold;
the apparatus being characterized in that the apparatus comprises individual feeding means for feeding a group of molds each time, and simultaneous feeding means for feeding a plurality of groups of molds at the same time, and carries out an individual feeding and a simultaneous feeding at respective timings.

2. The apparatus for producing optical element according to claim 1, which comprises in the conveying path a heating zone for heating a mold containing a molding material, a molding zone for press-molding the molding material, a cooling zone for cooling a mold after the molding, a mold reassembly zone for removing a top mold from the mold after the cooling, and placing the top mold on a bottom mold in which a new molding material is set, a product retrieving zone for retrieving a product from a bottom mold from which the top mold is removed, and a molding material supply zone for setting a molding material in the bottom mold from which the product was taken out; and
which further comprises a product collecting zone adjacently to the product retrieving zone, a molding material collecting zone adjacently to the molding material supply zone, and a sealing chamber filled with non-oxidative atmosphere, wherein the conveying path, the product collecting zone and the molding material collecting zone are provided in the sealing chamber.

3. The apparatus for producing optical element according to claim 2 wherein the heating zone is provided in the outgoing path, the molding zone is provided in the connecting path in the downstream side of the heating zone, and the cooling zone is provided in the returning path.

4. The apparatus for producing optical element according to claim 3, wherein the mold reassembly zone is provided in the middle of the returning path so as to continue from the cooling zone, and a top mold removed in the mold reassembly zone bypasses to an opposing position in the returning path side.

5. The apparatus for producing optical element according to claim 3, wherein the mold reassembly zone is provided in the connecting path in the downstream side of the cooling zone.

6. The apparatus for producing optical element according to claim 2, wherein the heating zone, the molding zone and the cooling zone are partitioned from other process zones in the conveying path by a partition wall having an opening through which the mold can pass.

7. The apparatus for producing optical element according to claim 2, wherein based on a zone requiring the shortest process duration among the heating zone, the molding zone and the cooling zone, the number of sections in each of other zones is determined.
